(19) United States
(12) Patent Application Publication
(10) Pub. No.: US 2009/0295028 A1
(43) Pub. Date: Dec. 3, 2009

(54) Process and apparatus for making multi-layered, multi-component filaments

(76) Inventors: Edgar N. Rudisill, Midlothian, VA (US); Michael C. Davis, Midlothian, VA (US); Vishal Bansal, Overland Park, KS (US); Gary Lee Sturgill, Lincoln University, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/156,459

(22) Filed: May 30, 2008

(51) Int. Cl. B29C 47/04

(52) U.S. Cl. 264/280; 425/131.5

(57) ABSTRACT

The present invention is directed to a process for forming a plurality of multi-layered filaments from multiple thermoplastic synthetic polymers and an apparatus containing a melt spinning beam which comprises multiple polymer inlet passages each communicating with separate multiple coat hanger distribution manifolds, separate filters connected downstream of each coat hanger distribution manifold, a combining manifold connected downstream of the filters and containing channels to retard polymer flow across planar molten polymer flow streams and a spinneret comprising a plurality of spinneret exit orifices connected downstream of the combining manifold for spinning of the multi-layered filaments.

### BACKGROUND OF THE INVENTION

1. Field of the Invention

This invention relates to a process and an apparatus for producing melt spun multi-layered cross section multi-component filaments.

2. Description of the Related Art

In a melt spinning process, thermoplastic synthetic polymers are melted and forced through orifices of a spinneret to form filaments. These filaments can be drawn or attenuated via air jets or mechanical means and collected on a moving porous surface to produce a random laydown of filaments or nonwoven web. The web can be bonded together to maintain its integrity. Also, in a melt blowing process, air jets can be added at the end of the spinneret to provide a very rapid drawing process providing very small diameter filaments.

In order to produce uniform filaments from a row of spinneret orifices, the polymer of each filament should be subjected to as nearly as possible the same heat history and residence time in the spinning apparatus. This can be accomplished using a polymer distribution manifold, which makes molten polymer with a longer travel distance move more quickly than molten polymer with a shorter travel distance. An example of a distribution manifold is a coat hanger (indicative of the general shape of the manifold) which can be found in U.S. Pat. Nos. 3,860,383; 4,043,739; 4,285,655; 5,728,407; and 6,120,276.

Bicomponent filaments which are made from two different polymers can also be melt spun. The separate molten polymer flow streams can be combined into layered polymer flow streams to make filaments with side-by-side cross sections in which filament portions each have distinct polymer components that extend for a significant portion of the length of each filament. An example of this in a meltblown process is U.S. Pat. No. 6,057,256. It is known, when making side-by-side cross section filaments, to combine polymer flow streams prior to using a coat hanger. Unfortunately, this eliminates the capacity for downstream filtering as filtering of the bicomponent melt stream would cause mixing of the layered polymer streams. It is also known, to use a coat hanger for each polymer flow stream and then to feed the polymer flow streams to a split hole die before being combined. Unfortunately, this split hole die can produce non-uniform filaments.

In systems where the polymers are not filtered, there are a significant number of spinneret orifices that plug during the start-up of the die and during operation, as the orifices are not protected from particles that come through the melt system. Essentially all melt processes will form particles that are large enough to plug the spin orifice. The source of these particles can be degraded polymer, gels, agglomerates, contaminants, etc. For most processes the typical number of plugged holes will start at 10-15 percent and will continue to increase during the run.

The above limitations are overcome as described in U.S. Pat. No. 6,605,248 (assigned to E.I. du Pont de Nemours and Company, Wilmington, Del.), which describes a melt spinning apparatus and process for making uniform multi-layered cross section filaments which allow for downstream filtering, creation of layered polymer flow streams, and extrusion of the layered polymer flow streams through common unitary dies.

However, even the process and apparatus described in U.S. Pat. No. 6,605,248 must be monitored for fluctuations in temperature or polymer viscosity that could lead to spinning discontinuities and non-uniform filaments.

Furthermore, it is desirable to make multi-layered cross section filaments from polymers with different spinning temperatures and viscosities.

Therefore, there is a need for a melt spinning apparatus and process for making uniform multi-layered cross section filaments which allow for downstream filtering, creation of layered polymer flow streams, and extrusion of the layered polymer flow streams through common unitary dies with an improved ability to spin polymers at different spinning temperatures and viscosities.

### SUMMARY OF THE INVENTION

In a first embodiment, the present invention is directed to a process for preparing a plurality of multi-layered filaments from multiple thermoplastic synthetic polymers comprising separately melting and extruding multiple thermoplastic synthetic polymers into separate molten polymer flow streams, distributing each of the separate molten polymer flow streams into separate coat hanger distribution manifolds to form a separate planar molten polymer flow stream of each of the polymers, passing the separate planar molten polymer flow streams through separate filters to filter the planar molten polymer flow streams, passing the filtered separate planar molten polymer flow streams exiting the filters through a combining manifold to form a multi-layered planar molten polymer flow stream wherein at least one of the filtered separate planar molten polymer flow streams and/or the multi-layered molten polymer flow stream travel along a path that is at least partially segregated along at least a portion of the path into two or more parallel channels to restrict the movement of the flow stream between channels, feeding the multi-layered planar molten polymer flow stream through a spinneret comprising a plurality of spinneret exit orifices to form multi-layered filaments, and attenuating the multi-layered filaments as they exit the plurality of spinneret exit orifices with a fluid exiting fluid jets positioned adjacent the plurality of spinneret exit orifices.

Another embodiment of the present invention is an apparatus for spinning a plurality of multi-layered filaments from multiple thermoplastic synthetic polymers comprising multiple extruders for separately melting and extruding multiple thermoplastic synthetic polymers into molten polymer flow streams, and a melt blowing beam comprising separate coat hanger distribution manifolds downstream of and communicating with the extruders, separate filters downstream of and extending essentially the length of the melt blowing beam and communicating with the coat hanger distribution manifolds, a combining manifold comprising converging passages downstream of and communicating with the filters, the converging passages extending the length of and exiting the filters for combining the separate filtered planar molten polymer flow streams into a multi-layered planar molten polymer flow stream wherein at least one of the filtered separate planar molten polymer flow streams and/or the multi-layered molten polymer flow stream travel along a path that is at least partially segregated with ridges along at least a portion of the path into two or more parallel channels to restrict the movement of the flow stream between channels, a spinneret downstream of and communicating with the combining manifolds comprising a plurality of spinneret exit orifices, and fluid jets positioned adjacent the spinneret exit orifices.

### BRIEF DESCRIPTION OF THE DRAWINGS

FIG. 1 is a schematic diagram of a transverse cross section of a melt spinning beam for producing side-by-side cross section bicomponent filaments according to the present invention.

FIG. 2 is a schematic view of a surface of a transfer slot of the melt spinning beam.

### DETAILED DESCRIPTION OF THE INVENTION

The term multi-layered filaments as used herein means filaments with a first polymer layer extending longitudinally along the fiber in contact with a second polymer layer extending longitudinally along the fiber with the second polymer optionally in contact with one or more other polymer layers.

The term multiple thermoplastic synthetic polymers as used herein means more than one distinct or dissimilar synthetically prepared heat processible polymer. This includes, but is not limited to, polyolefins, polyesters and polyamides. It also includes homopolymers, copolymers and blends of polymers.

The term molten polymer flow streams as used herein means a polymer heated above its melting point that can flow through a spinning apparatus.

The term planar molten polymer flow streams as used herein means a molten polymer flow stream that generally has a high width-to-height ratio cross section.

The term multi-layered molten polymer flow stream as used herein means a molten polymer flow stream made from two or more dissimilar planar molten flow streams wherein the planar molten flow streams are in contact along the width of the cross section of the flow streams.

The term distribution manifold as used herein means a device for spreading a polymer flow stream into a generally high width-to-height ratio cross section preferably with the polymer all along the flow stream cross section being subjected to nearly the same heat history.

The term combining manifold as used herein means a device for coupling two or more planar molten polymer flow streams into a multi-layered molten polymer flow stream.

The present invention is directed to melt spinning uniform multi-layered cross section multi-component filaments. These filaments can be collected on a forming screen and bonded together to produce a nonwoven web. This web can be used, for example, in filters, apparel, wipes, and hygiene products.

According to the invention, multiple thermoplastic synthetic polymers are separately melted into molten polymer flow streams, distributed into planar molten polymer flow streams, filtered, combined into a multi-layered molten polymer flow stream wherein at least one of the filtered separate planar molten polymer flow streams and/or the multi-layered molten polymer flow stream travel along a path that is at least partially segregated along at least a portion of the path into two or more parallel channels to restrict the movement of the flow stream between channels, fed to a plurality of spinneret exit orifices and as the multi-layered molten polymer flow stream emerges from the spinneret exit orifice it can be cooled and attenuated with high speed fluid, such as air from fluid jets to produce the multi-layered cross section filaments. These filaments can have very small fiber diameters.

The present invention is an improvement on the invention described in U.S. Pat. No. 6,605,248, herein incorporated by reference, which describes a melt spinning apparatus and process for making uniform multi-layered cross section filaments which allow for downstream filtering, creation of layered polymer flow streams, and extrusion of the layered polymer flow streams through common unitary dies. The present invention improves on U.S. Pat. No. 6,605,248 by allowing for spinning polymers with fluctuations in or mismatched spinning temperatures and polymer viscosities by at least partially segregating at least one of the planar molten polymer flow streams and/or the multi-layered molten polymer flow stream in the combining manifold to retard polymer flow across the molten polymer flow streams.

In multiple component filaments, the multiple thermoplastic synthetic polymers comprise at least two dissimilar polymers, which can be either chemically or physically dissimilar. The polymers can include polyolefins, polyesters and polyamides, and can be homopolymers, co-polymers or blends of polymers.

The polymers are melted into separate molten polymer flow streams using conventional means, such as extruders, and forced through separate distribution manifolds to produce separate planar molten polymer flow streams. The distribution manifolds arrange the molten polymer flow streams into long thin planes of molten polymer, wherein the polymer all along the plane has nearly the same heat history and residence time. It is optimal for the molten polymer stream to have as much as possible the same heat history and residence time in order to minimize degradation of the polymer contacting the manifold walls, which tends to form solidified particles which can plug the spinneret orifices downstream, and/or form less uniform spun filaments. A common distribution manifold is a coat hanger manifold, which is named as such due to its general resemblance (in longitudinal cross section) in form to a coat hanger. Due to the long, thin form of the coat hanger distribution manifold, heat from the walls of the melt spinning beam is transferred through the molten polymer almost instantaneously, thus minimizing heat gradients within the spin beam and reducing non-uniform heating of the polymer.

Likewise, due to the shape of the coat hanger distribution manifold, molten polymer which has a longer distance to travel within the manifold travels at a faster rate than that which has a shorter distance to travel. Accordingly, upon proper design of the coat hanger distribution manifold, all molten polymer within the manifold will have nearly identical residence time.

In spite of the use of coat hanger distribution manifolds, the molten polymer within the spinning beam is invariably somewhat degraded at the interface with the walls of the spinning beam, both within the coat hanger manifold and in the inlet passages to the spinning beam. Accordingly, in the present invention, the planar molten polymer flow streams are individually filtered prior to being combined, but downstream of the coat hanger distribution manifolds, greatly reducing or eliminating unwanted particulate passing into the spinneret which might plug the spinneret exit orifices. In this manner, each of the multiple molten polymer streams can be filtered, without causing upsets in flow after combination of the streams, which would adversely affect the layered natures of the streams and therefore the resulting filaments.

The filtered planar molten polymer flow streams are combined in a combining manifold to form a multi-layered planar molten polymer flow stream wherein at least one of the filtered separate planar molten polymer flow streams and/or the multi-layered molten polymer flow stream travel along a path that is at least partially segregated along at least a portion of the path into two or more parallel channels to restrict the movement of the flow stream between channels.

The multi-layered molten polymer flow stream is spun through a common unitary die having spinneret exit orifices with fluid exiting fluid jets positioned adjacent the plurality of spinneret exit orifices to produce multi-layered filaments. The layering of the polymers can be in any order and can be repeated as often as desired. Each layer contacts the surface of the filaments and extends for a significant portion of the length of the filaments.

In the simplest example, the filaments containing only two dissimilar polymers to prepare filaments of the invention are called bicomponent filaments. Also, in the instance of two layers, the filaments are called side-by-side cross section filaments. In another embodiment of the invention, the spinning beam may contain more than two flow pathways for more than two molten polymer streams. Thus, if three-component filaments are desired, the spinning beam would be configured to have three separate polymer inlet passages, three separate coat hanger distribution manifolds and three separate filters, which all feed into a single combination manifold, wherein the separate molten polymer streams are combined as a three-layered molten polymer stream, which feeds the spinneret exit orifices downstream to form three-component filaments as they exit the spinning beam. The skilled artisan will recognize that any number of separate flowpaths can be formed within the spinning beam, so as to form multiple-component filaments.

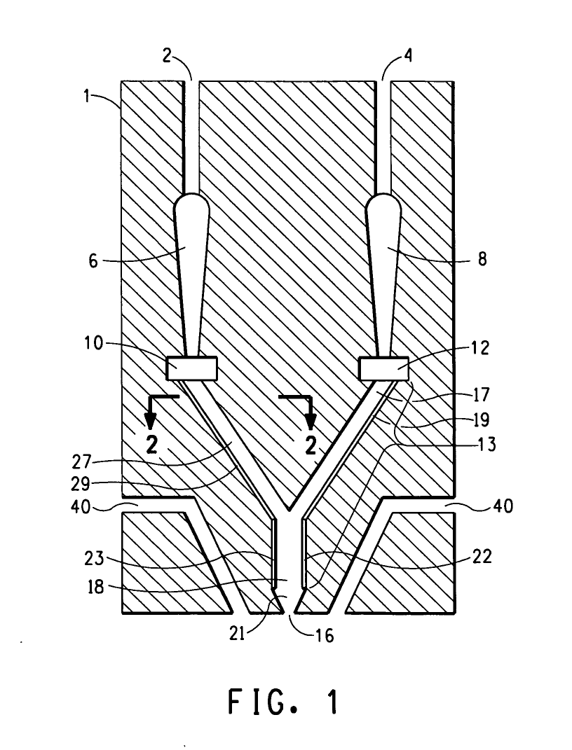

The invention can be described with reference to a specific example of preparing side-by-side cross section bicomponent filaments according to the spinning apparatus of FIG. 1.

FIG. 1 is a transverse cross sectional view of a two-component orthogonal spinning beam 1, which extends in the longitudinal direction, i.e. perpendicular to the plane of the page, for several meters. Two different thermoplastic synthetic polymers are separately melted in separate extruders (not shown) and fed into the spinning beam through inlet passages 2 and 4. The molten polymer is transported to two coat hanger distribution manifolds 6 and 8, which direct the molten polymer flow streams into two planar molten polymer flow streams. By careful selection of manifold geometry, all of the polymer has nearly the same temperature, viscosity and residence time in the manifold along the length of the plane of the molten polymer flow stream. The planar molten polymer flow streams are individually filtered through filters 10 and 12, which extend the length of the melt spinning beam. The filtered separate planar molten polymer flow streams are fed through a combining manifold 13 and are combined into a two-layered planar molten polymer stream. The combining manifold 13 comprises separate transfer slots 17 and 27 and a combining slot 18.

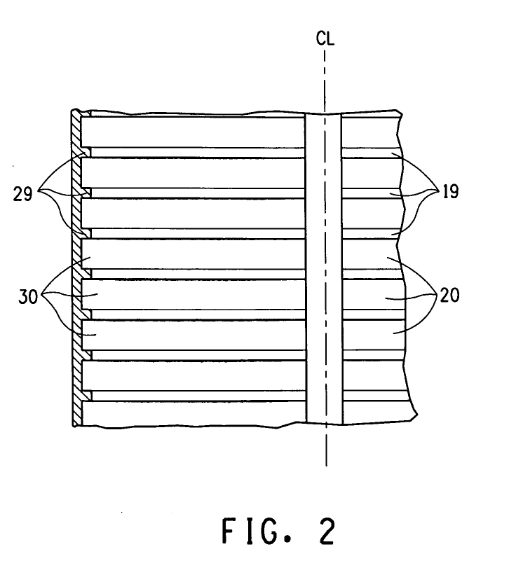

The integrity of the filtered separate planar molten polymer flow streams and the two-layered molten polymer flow stream traveling through the combining manifold 13 are enhanced by the presence of at least one of the filtered separate planar molten polymer flow streams and/or the multi-layered molten polymer flow stream traveling along a path that is at least partially segregated along at least a portion of the path into two or more parallel channels 20 or 30 (as in FIG. 2), separated by one or more ridges 19 or 29 in transfer slots 17 or 27, respectively. Similarly, the presence of one or more ridges 22 or 23 in combining slot 18 restrict the movement of a flow stream between channels. The channels can be used in one or more transfer slots, the combining slot, or both transfer slots and the combining slot. The ridges can partially or can completely segregate the polymer into channels. The multi-layered planar molten polymer flow stream is fed to a spinneret 21 comprising a plurality of spinneret exit orifices 16 to form side-by-side filaments. It should be noted that the combining slot 18 can be minimized in length to be essentially absent from this apparatus between transfer slots 17 and 27 and spinneret 21. As the two-layered molten polymer flow stream emerges from the spinneret orifices, the two-layered molten polymer flow stream can be cooled and attenuated with high speed fluid, such as air, exiting jets 40 to form very small diameter filaments. The combining manifold and the spinneret can be combined into one device.

### EXAMPLES

The following example of the invention describes the preparation of a web of meltblown bicomponent fibers according to the process described above with reference to the apparatus of FIG. 1 and FIG. 2. The comparative example is made similarly but without some of the apparatus elements of the invention.

### Example 1

A meltblown bicomponent web of the invention is made from melt blown fibers with a polyethylene component and a poly (ethylene terephthalate) component. The polyethylene component is made from linear low density polyethylene with a melt index of 135 g/10 minutes available from Equistar as GA594. The polyester component is made from poly (ethylene terephthalate) with an intrinsic viscosity of 0.53 available from E. I. du Pont de Nemours and Company as Crystar® polyester (Merge 4449). The polyethylene polymer is heated to 260° C. and the polyester polymers heated to 305° C. in separate extruders. The two polymers are separately extruded and metered to two independent coat hanger-type polymer distributors. The planar melt stream exiting each distributor are filtered independently and then are combined in a combining manifold within a bicomponent meltblowing die to provide a two-layered molten polymer flow stream. The combining manifold comprises a transfer slot for each filtered planar melt stream with each transfer slot having 10 ridges blocking 50% of the thickness of the filtered planar melt stream and segregating the filtered planar melt stream to flow through 11 channels. The combining manifold also comprises a combining slot which did not contain any ridges. The die is heated to 280° C. The die has 645 capillary openings arranged in a 54.6 cm line. The polymers are spun through the each capillary at a polymer throughput rate of 0.80 g/hole/min. Attenuating air is heated to a temperature of 305° C. and is supplied at a pressure of 7 psig through two 1.5 mm wide air jets. The two air jets run the length of the 54.6 cm line of capillary openings, with one jet on each side of the line of capillaries set back 1.5 mm from the capillary openings. The polyethylene is supplied to the spin pack at a rate of 6.2 kg/hr and the polyester is supplied to the spin pack at a rate of 24.8 kg/hr. A bicomponent side-by-side filament meltblown web is produced that contains 20 weight percent polyethylene and 80 weight percent polyester. The filaments are collected at a die-to-collector distance of 12.7 cm on a moving forming screen to produce a meltblown web. The meltblown web is collected on a roll. The meltblown web has a basis weight of 17 g/m².

### Comparative Example A

A web is made according to the procedure in Example 1 except without the use of the ridges in the transfer slot. This process provides instabilities in fiber formation that result in fiber non-uniformity with some filaments containing only one polymer.

These examples show that the use of ridges to at least partially segregate planar molten polymer flow streams and/or the multi-layered molten polymer flow stream in the combining manifold allow for spinning polymers with fluctuations in or mismatched polymer spinning viscosities in order to avoid non-uniformities in filaments.

What is claimed is:

1. A process for preparing a plurality of multi-layered filaments from multiple thermoplastic synthetic polymers comprising:
separately melting and extruding multiple thermoplastic synthetic polymers into separate molten polymer flow streams;
distributing each of the separate molten polymer flow streams into separate coat hanger distribution manifolds to form a separate planar molten polymer flow stream of each of the polymers;
passing the separate planar molten polymer flow streams through separate filters to filter the planar molten polymer flow streams;
passing the filtered separate planar molten polymer flow streams exiting the filters through a combining manifold to form a multi-layered planar molten polymer flow stream wherein at least one of the filtered separate planar molten polymer flow streams and/or the multi-layered molten polymer flow stream travel along a path that is at least partially segregated along at least a portion of the path into two or more parallel channels to restrict the movement of the flow stream between channels;
feeding the multi-layered planar molten polymer flow stream through a spinneret comprising a plurality of spinneret exit orifices to form multi-layered filaments; and
attenuating the multi-layered filaments as they exit the plurality of spinneret exit orifices with a fluid exiting fluid jets positioned adjacent the plurality of spinneret exit orifices.

2. The process of claim 1, wherein the at least one of the filtered separate planar molten polymer flow streams and/or the multi-layered molten polymer flow stream travel along a path consisting of the path containing the at least one of the filtered separate planar molten polymer flow streams.

3. The process of claim 1, wherein the at least one of the filtered separate planar molten polymer flow streams and/or the multi-layered molten polymer flow streams travel along a path consisting of the path containing the multi-layered molten polymer flow stream.

4. The process of claim 1, wherein the at least one of the filtered separate planar molten polymer flow streams and/or the multi-layered molten polymer flow stream travel along a path comprises the path containing the at least one of the filtered separate planar molten polymer flow streams and the multi-layered molten polymer flow stream.

5. The process of claim 1, wherein the channels are completely segregated from one another.

6. The process of claim 1, wherein the number of multiple thermoplastic synthetic polymers is two.

7. The process of claim 1, wherein the number of multiple thermoplastic synthetic polymers is greater than two.

8. An apparatus for spinning a plurality of multi-layered filaments from multiple thermoplastic synthetic polymers comprising:
multiple extruders for separately melting and extruding multiple hermoplastic synthetic polymers into molten polymer flow streams;
and a melt blowing beam comprising: separate coat hanger distribution manifolds downstream of and communicating with the extruders; separate filters downstream of and extending essentially the length of the melt blowing beam and communicating with the coat hanger distribution manifolds; a combining manifold comprising converging passages downstream of and communicating with the filters, the converging passages extending the length of and exiting the filters for combining the separate filtered planar molten polymer flow streams into a multi-layered planar molten polymer flow stream wherein at least one of the filtered separate planar molten polymer flow streams and/or the multi-layered molten polymer flow stream travel along a path that is at least partially segregated with ridges along at least a portion of the path into two or more parallel channels to restrict the movement of the flow stream between channels; a spinneret downstream of and communicating with the combining manifolds comprising a plurality of spinneret exit orifices; and fluid jets positioned adjacent the spinneret exit orifices.

9. The apparatus of claim 8, wherein the channels are completely segregated from one another.

10. The apparatus of claim 8, which is configured for two thermoplastic synthetic polymers.

11. The apparatus of claim 8, which is configured for more than two thermoplastic synthetic polymers.
